(19) United States
(12) Patent Application Publication
(10) Pub. No.: US 2023/0043022 A1
(43) Pub. Date: Feb. 9, 2023

(54) SEALING RING

(71) Applicant: Carl Freudenberg KG, Weinheim (DE)

(72) Inventors: Erich Prem, Hemsbach (DE); Benjamin Kohl, Rauenberg (DE); Daniel Froelich, Weinheim (DE)

(21) Appl. No.: 17/878,932

(22) Filed: Aug. 2, 2022

(30) Foreign Application Priority Data
Aug. 4, 2021 (DE) 10 2021 120 283.3

(51) Int. Cl. F16J 15/3232

(52) U.S. Cl. CPC F16J 15/3232; F16J 15/3212

(57) ABSTRACT

A sealing ring includes: a sealing body of a rubber-elastic sealing material; and an intermediate element which is connected to the sealing body. The sealing body includes a retaining collar which delimits an undercut. The intermediate element is arranged in the undercut and assigned to the retaining collar in a non-adhered and non-destructively detachable manner.

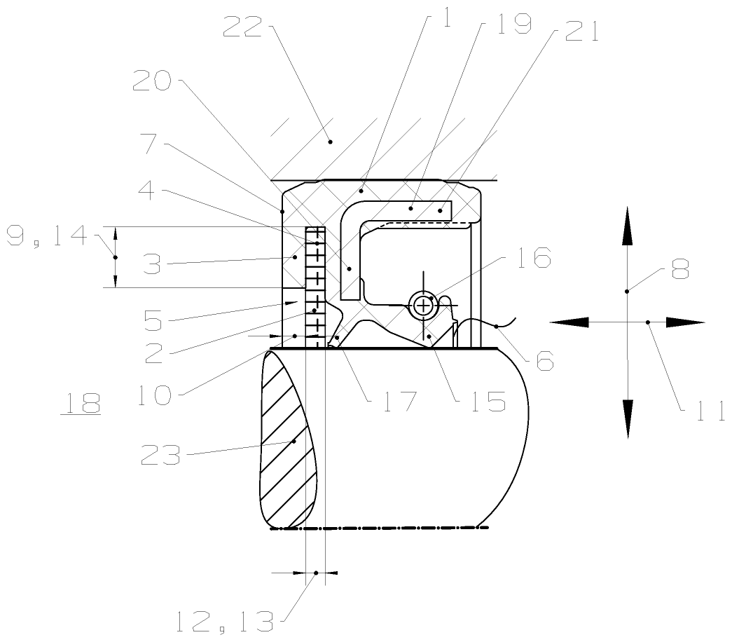

### CROSS-REFERENCE TO PRIOR APPLICATION

Priority is claimed to German Patent Application No. DE 10 2021 120 283.3, filed on Aug. 4, 2021, the entire disclosure of which is hereby incorporated by reference herein.

### FIELD

The invention relates to a sealing ring comprising a sealing body, made of a rubber-elastic sealing material, and an intermediate element which is connected to the sealing body.

### BACKGROUND

Such a sealing ring is generally known. The intermediate element may, for example, be constituted by a non-woven disk, a PTFE disk or a baffle plate, depending upon the application.

The sealing body and the intermediate element have, for example, been bonded to one another or otherwise connected by material closure.

In economic respects, with regard to the most diverse possible combinations of sealing bodies and intermediate elements with one another and as regards good environmental compatibility, such a connection is not very satisfactory.

### SUMMARY

In an embodiment, the present invention provides a sealing ring, comprising: a sealing body comprising a rubber-elastic sealing material; and an intermediate element which is connected to the sealing body, wherein the sealing body includes a retaining collar which delimits an undercut, and wherein the intermediate element is arranged in the undercut and assigned to the retaining collar in a non-adhered and non-destructively detachable manner.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

The FIGURE shows a sealing ring according to the invention in schematic representation.

### DETAILED DESCRIPTION

In an embodiment, the present invention d further a sealing ring of the aforementioned type in such a manner that it has a modular structure, so that sealing bodies and intermediate elements, adapted in each instance for the respective application, are capable of being combined with one another in diverse ways, and that such a sealing ring is capable of being produced easily and inexpensively and capable of being recycled in environmentally sound and homogeneous manner subsequent to its use.

In an embodiment, the present invention provides a sealing body that includes a retaining collar which delimits an undercut, and that the intermediate element is arranged in the undercut and assigned to the retaining collar in non-adhered and non-destructively detachable manner.

In this connection, it is an advantage that the sealing ring is of modular construction, so that differing intermediate elements and differing sealing bodies are capable of being easily combined with one another as needed.

The connection of the sealing body and the intermediate element is simple and inexpensive. The sealing body and the intermediate element are connected to one another by a plug-in connection. A connection by material closure does not find application.

For the purpose of mounting the sealing ring, the intermediate element is inserted into the undercut and retained in the undercut by the retaining collar in non-adhered and non-destructively detachable manner.

If, for example in the case of a service, an intermediate element utilized hitherto is to be replaced by a new or different intermediate element, the intermediate element utilized hitherto is removed from the undercut, subject to elastic deformation of the rubber-elastic retaining collar. Subsequently the new intermediate element is mounted in the undercut, likewise subject to elastic deformation of the rubber-elastic retaining collar.

The sealing body and the intermediate element are positively connected to one another by the plug-in connection. By virtue of the fact that the sealing body and the intermediate element have been connected to one another in non-adhered and non-destructively detachable manner, the individual parts that the sealing ring consists of can be easily separated from one another subsequent to use as intended, and then recycled homogeneously.

The intermediate element and the retaining collar may have been arranged on the front side of the sealing body facing axially away from the medium to be sealed off. In such a case, the sealing lips of the sealing body are protected by the intermediate element against loading with pollutants from the environment.

Generally, however, there is also the possibility that the intermediate element and the retaining collar have been arranged on the front side of the sealing body facing axially toward a medium to be sealed off. In such a case, the intermediate element may be constituted, for example, by a baffle plate which allows medium to be sealed off to penetrate to a main sealing lip of the sealing body only to a reduced extent.

The retaining collar is preferably closed in itself in the form of a circular ring. Such a configuration has the advantage that the intermediate element is retained in the undercut particularly reliably during the entire service life of the sealing ring.

Deviating from this, there is the possibility that the retaining collar is constituted by segments of annular design which, viewed in the peripheral direction, have been assigned to one another, spaced adjacently. In such a configuration, it is an advantage that the mounting/demounting of the intermediate element in and out of the undercut can be undertaken particularly easily.

There is a good compromise between a simple mounting/demounting of the intermediate element in and out of the undercut and a permanently reliable arrangement of the intermediate element in the undercut if the retaining collar exhibits a height in the radial direction and a thickness in the axial direction that substantially correspond to the axial width of the undercut and therefore to the axial breadth of the intermediate element.

The height preferably corresponds to the radial depth of the undercut, the ratio of height to thickness of the retaining collar preferably amounting to 1.5 to 2.5. As a result, the retaining collar is, on the one hand, sufficiently elastically yielding so that the intermediate element can be easily mounted in the undercut and demounted out of the undercut, and, on the other hand, rigid enough to connect the intermediate element to the sealing body reliably during a long service life of the sealing ring.

As already explained previously, by virtue of the plug-in connection between the sealing body and the intermediate element practically any intermediate elements can be connected to the sealing body in modular manner. The intermediate element may, for example, be constituted by a disk made of a non-woven material or of PTFE, or by a baffle plate.

Depending on the respective given conditions of the application, one and the same sealing body can, for example, be easily combined with the intermediate element adapted to the application.

Such a sealing ring can be used in versatile manner in mechanical engineering, in particular in automotive engineering, for instance in the drivetrain, in the region of the gearbox output, for engine sealing or for axle sealing, or in machines in the food industry—that is to say, wherever the sealing lips of the sealing body are to be protected by the intermediate element against undesirable influences.

An embodiment of the sealing ring according to the invention will be elucidated in more detail in the following with reference to the FIGURE.

In the FIGURE, a sealing ring according to the invention is shown in schematic representation.

The sealing ring takes the form of a radial shaft-sealing ring and has been represented mounted in a sealing arrangement. The sealing ring includes, radially on the inside on the side facing axially toward the medium 6 to be sealed off, a sealing lip 15 which is delimited radially on the inside by conic surfaces intersecting one another and accommodates an annular spiral coiled spring 16 radially on the outer periphery.

On the side of the sealing lip 15 facing axially away from the medium 6 to be sealed off, a dust lip 17 is provided as protection of the sealing lip 15 against loading with pollutants from the environment 18.

In addition, the sealing ring includes an L-shaped supporting ring 19 made of a tough material and arranged in the sealing body 1, with a radial leg 20 and with an axial leg 21.

The sealing lip 15 and the dust lip 17 are hinged radially on the inside of the radial leg 20. The axial leg 21 is enclosed on the outer periphery by the elastomeric material of the sealing body 1. The sealing ring is held in a bore of a housing 22 by the axial leg 21.

The sealing lip 15 encloses a shaft 23 to be sealed off in sealing manner, subject to radial initial tension.

The retaining collar 3, which delimits the undercut 4, is arranged on the front side 7 of the sealing body 1 facing axially away from the medium 6 to be sealed off.

The intermediate element 2, which in the embodiment shown here is disk-shaped, is arranged in the undercut 4 in non-adhered and non-destructively detachable manner. This non-adhered and non-destructively detachable assignment is brought about by a positively effective plug-in connection 5.

In order to obtain a simple mounting/demounting of the intermediate element 2 out of the undercut 4, the rubber-elastic retaining collar 3 has a height 9 in the radial direction 8 and a thickness 10 in the axial direction 11 that substantially correspond to the axial width 12 of the undercut 4. The axial width 12 of the undercut 4 corresponds practically to the axial breadth 13 of the intermediate element 2.

The retaining collar 3 constitutes an integral and materially uniform component of the sealing body 1 and therefore also consists of a rubber-elastic sealing material.

The height 9 corresponds to the radial depth 14 of the undercut 4, the ratio of height 9 to thickness 10 of the retaining collar 3 amounting to about two in the embodiment shown here. As a result, the intermediate element 2 can be easily mounted in the undercut 4 and easily demounted out of the undercut 4, and the positive closure of the plug-in connection 5 holds reliably during the entire service life of the sealing ring.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A sealing ring, comprising:
a sealing body comprising a rubber-elastic sealing material; and
an intermediate element which is connected to the sealing body,
wherein the sealing body includes a retaining collar which delimits an undercut, and
wherein the intermediate element is arranged in the undercut and assigned to the retaining collar in a non-adhered and non-destructively detachable manner.

2. The sealing ring of claim 1, wherein the sealing body and the intermediate element are positively connected to one another by a plug-in connection.

3. The sealing ring of claim 1, wherein the intermediate element and the retaining collar are arranged on a front side of the sealing body facing axially away from a medium to be sealed.

4. The sealing ring of claim 1, wherein the retaining collar is closed in itself as a circular ring.

5. The sealing ring of claim 1, wherein a height of the retaining collar in a radial direction and a thickness in an axial direction substantially correspond to an axial width of the undercut and to an axial breadth of the intermediate element.

6. The sealing ring of claim 5, wherein the height corresponds to a radial depth of the undercut, and
wherein a ratio of height to thickness of the retaining collar is 1.5 to 2.5.

7. The sealing ring of claim 1, wherein the intermediate element comprises a disk comprising a non-woven material or PTFE, or a baffle plate.
